(19) United States
(12) Patent Application Publication
(10) Pub. No.: US 2025/0136792 A1
(43) Pub. Date: May 1, 2025

(54) PLASTIC COMPOSITE MATERIAL COMPRISING COFFEE GROUNDS AND METHOD FOR PREPARING SAME, AND PRODUCT USING SAME AND CHARACTERISTICS OF PRODUCT

(71) Applicants: Samsung Electronics Co., Ltd., Suwon-si (KR); IL KWANG POLYMER. CO.,LTD, Hwaseong-si (KR)

(72) Inventors: Jinhyeong PARK, Suwon-si (KR); Eunkyung LEE, Hwaseong-si (KR); Hankyum LEE, Suwon-si (KR); Doorae KIM, Suwon-si (KR); Minhyouk KIM, Suwon-si (KR); Youngnam KIM, Suwon-si (KR); Youngoh KIM, Suwon-si (KR); Jonghwa KIM, Suwon-si (KR); Seongho PARK, Hwaseong-si (KR); Jeongseok PARK, Suwon-si (KR); Yeongjune SONG, Hwaseong-si (KR); Sanhui OH, Suwon-si (KR); Jaemin OK, Hwaseong-si (KR); Houk LEE, Hwaseong-si (KR); Byonghee CHO, Hwaseong-si (KR)

(21) Appl. No.: 19/009,378

(22) Filed: Jan. 3, 2025

Related U.S. Application Data
(63) Continuation of application No. PCT/KR2023/005114, filed on Apr. 14, 2023.

(30) Foreign Application Priority Data
Jul. 5, 2022 (KR) 10-2022-0082315
Aug. 29, 2022 (KR) 10-2022-0108636

(51) Int. Cl. C08K 11/00

(52) U.S. Cl. CPC C08K 11/005; C08K 2201/018

(57) ABSTRACT

A plastic composite material comprising coffee grounds is provided. The plastic composite material includes coffee grounds, wherein the particle size distribution of the coffee grounds has a particle size distribution of 94% by weight or more for coffee ground particles having a particle size greater than 250 μm and less than or equal to 850 μm, and wherein the plastic composite material has a colorimeter value of 4.4 or less.

### CROSS-REFERENCE TO RELATED APPLICATION(S)

This application is a continuation application, claiming priority under 35 U.S.C. § 365(c), of an International application No. PCT/KR2023/005114, filed on Apr. 14, 2023, which is based on and claims the benefit of a Korean patent application number 10-2022-0082315, filed on Jul. 5, 2022, in the Korean Intellectual Property Office, and of a Korean patent application number 10-2022-0108636, filed on Aug. 29, 2022, in the Korean Intellectual Property Office, the disclosure of each of which is incorporated by reference herein in its entirety.

### JOINT RESEARCH AGREEMENT

The disclosure was made by or on behalf of the below listed parties to a joint research agreement. The joint research agreement was in effect on or before the date the disclosure was made and the disclosure was made as a result of activities undertaken within the scope of the joint research agreement. The parties to the joint research agreement are 1) Samsung Electronics Co., Ltd., and 2) Il Kwang Polymer. Co., Ltd.

### BACKGROUND

### 1. Field

The disclosure relates to plastic composite materials. More particularly, the disclosure relates to plastic composite materials including coffee grounds, methods for manufacturing same, products using same, and characteristics of the product.

### 2. Description of Related Art

With the development of the economy and industry, various materials or molded products made of plastic are being used. Although various molded products made of plastic exhibit superior durability due to their resistance to oxidation and decomposition, they do not decompose naturally, thus contributing to environmental pollution.

As a result, eco-friendly plastic technology is emerging, and there is active research on plastics utilizing biomass such as plant by-products or plant-based organic materials.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide plastic composite materials including coffee grounds, methods for manufacturing same, products using same, and characteristics of the product.

Additional aspects will be set forth in part in the description which follows and, in part, will be apparent from the description, or may be learned by practice of the presented embodiments.

In accordance with an aspect of the disclosure, a plastic composite material is provided. The plastic composite material includes coffee grounds, wherein the coffee grounds have a particle size distribution of 94% by weight or more for coffee ground particles with a particle size greater than 250 μm and less than or equal to 850 μm, and the plastic composite material has a colorimetric value of 4.4 or less.

In accordance with another aspect of the disclosure, a method for manufacturing a plastic composite material including coffee grounds is provided. The method includes preparing coffee grounds and biomass, drying the coffee grounds and the biomass, freeze-grinding the dried coffee grounds, wherein the coffee grounds formed by grinding the dried coffee grounds have a particle size distribution of 94% by weight or more for coffee grounds particles with a particle size greater than 250 μm and less than or equal to 850 μm, primarily extruding a first mixture obtained by mixing a polymer resin, the ground coffee grounds, the dried biomass, and a first additive, secondarily extruding a second mixture obtained by mixing the primary extrudate extruded in the primary extrusion process and a second additive, and drying the secondary extrudate extruded in the secondary extrusion process.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a flowchart illustrating a method for manufacturing a plastic composite material including coffee grounds according to an embodiment of the disclosure;

FIGS. 2A and 2B are diagrams of a cylindrical drying device according to various embodiments of the disclosure;

FIG. 3 is a graph illustrating the particle size distribution of coffee grounds before and after freeze-grinding according to an embodiment of the disclosure;

FIG. 4A is a diagram illustrating a plastic composite material according to an embodiment of the disclosure;

FIG. 4B is a view illustrating a plastic composite material according to an embodiment of the disclosure;

FIG. 5 is a graph showing the impact strength of a plastic composite material according to an embodiment of the disclosure;

FIG. 6A is a view illustrating a plastic composite material according to an embodiment of the disclosure;

FIG. 6B is a view illustrating a plastic composite material according to an embodiment of the disclosure;

FIG. 6C is a view illustrating a plastic composite material according to an embodiment of the disclosure;

FIG. 6D is a view illustrating a plastic composite material according to an embodiment of the disclosure;

FIG. 7A is an image illustrating a plastic composite material according to an embodiment of the disclosure;

FIG. 7B is an image illustrating a plastic composite material according to an embodiment of the disclosure;

FIGS. 8A and 8B are images illustrating plastic composite materials according to various embodiments of the disclosure;

FIG. 8C is an image illustrating a plastic composite material according to an embodiment of the disclosure;

FIGS. 9A and 9B are diagrams illustrating a cover member composed of a plastic composite material according to various embodiments of the disclosure; and

FIG. 10 is a diagram illustrating a cover member composed of a plastic composite material according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that various embodiments of the disclosure and the terms used therein are not intended to limit the technological features set forth herein to particular embodiments and include various changes, equivalents, or alternatives for a corresponding embodiment. With regard to the description of the drawings, similar reference numerals may be used to designate similar or relevant elements. As used herein, each of such phrases as “A or B,” “at least one of A and B,” “at least one of A or B,” “A, B, or C,” “at least one of A, B, and C,” and “at least one of A, B, or C” may include all possible combinations of the items enumerated together in a corresponding one of the phrases. As used herein, such terms as “a first,” “a second,” “the first,” and “the second” may be used to simply distinguish a corresponding element from another, and does not limit the elements in other aspect (e.g., importance or order).

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

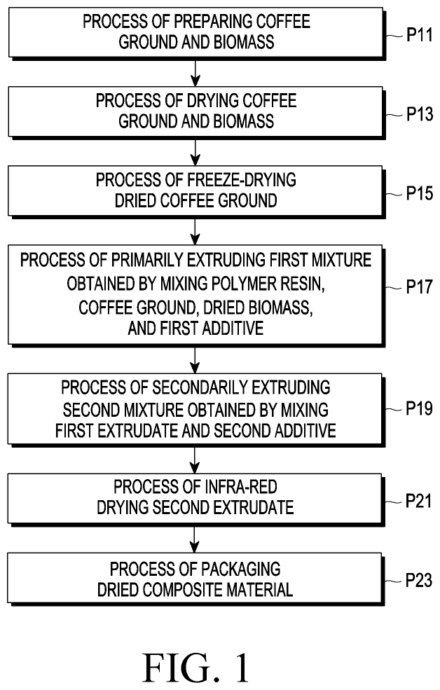

FIG. 1 is a flowchart illustrating a method for manufacturing a plastic composite material including coffee grounds according to an embodiment of the disclosure.

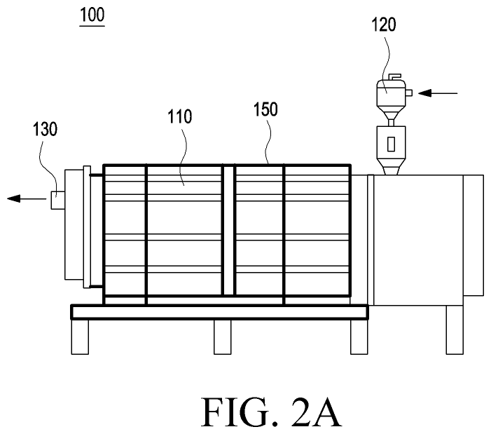

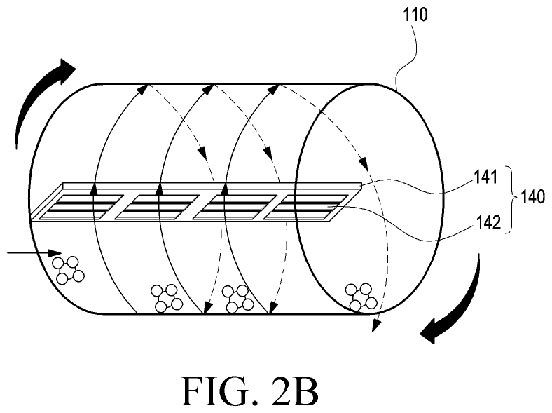

FIGS. 2A and 2B are diagrams of a cylindrical drying device according to various embodiments of the disclosure.

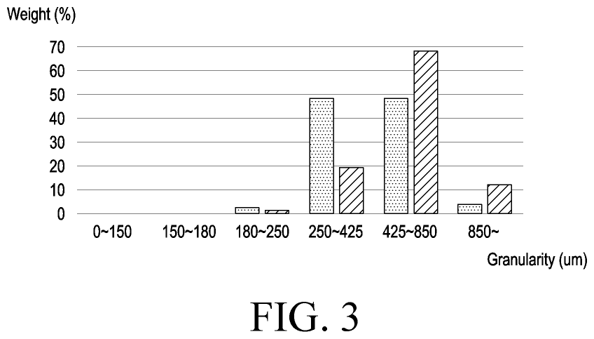

FIG. 3 is a graph illustrating the particle size distribution of coffee grounds before and after freeze grinding according to an embodiment of the disclosure.

Referring to FIG. 1, a method for manufacturing a plastic composite material including coffee grounds may include the processes of: preparing coffee grounds and biomass (P11); drying the coffee grounds and biomass (P13); freeze-grinding the dried coffee grounds (P15); primarily extruding a first mixture obtained by mixing a polymer resin, ground coffee grounds, dried biomass, and a first additive (P17); secondarily extruding a second mixture obtained by mixing the primary extrudate with a second additive (P19); drying the secondary extrudate using infrared radiation (P21); or packaging the dried composite material (P23).

According to an embodiment, the method for manufacturing a plastic composite material including coffee grounds may include a process (P11) of preparing coffee grounds and biomass. In an embodiment, coffee grounds may be a by-product or residue left after extracting coffee liquid from coffee beans. In an embodiment, biomass may be a plant by-product or plant waste. In an embodiment, biomass may include at least one of wood meal, rice straw, rice husk, rice bran, soybean hull, or wheat bran. In an embodiment, biomass may include various plant by-products or plant wastes without being limited to the aforementioned compositions.

According to an embodiment, the method for manufacturing a plastic composite material including coffee grounds may include a process (P13) of drying the coffee grounds and biomass. In an embodiment, the process (P13) of drying the coffee grounds and biomass may be performed separately. In an embodiment, the process (P13) of drying the coffee grounds and biomass may include an infrared irradiation process or an ultraviolet (UV) irradiation process.

In an embodiment, the infrared or ultraviolet irradiation process may be carried out through a cylindrical drying device (e.g., cylindrical drying device (100) in FIGS. 2A and 2B).

Referring to FIGS. 2A and 2B, the cylindrical drying device (100) may include a rotating housing (110), an inlet (120), an outlet (130), an infrared drying section (140), and/or an ultraviolet irradiation section.

In an embodiment, the rotating housing (110) may be a cylindrical housing with an internal space formed therein, and may be mounted on a support structure (150) so that the central axis of the circular cross-section of the rotating housing (110) is substantially parallel to the ground or floor surface. In an embodiment, the rotating housing (110) may be rotatably mounted with respect to the support structure (150). In an embodiment, as the rotating housing (110) rotates about the central axis, the rotating housing (1100 may stir the coffee grounds or biomass introduced into the interior thereof.

In an embodiment, the inlet (120) may be configured to connect to the rotating housing (110) directly or indirectly via a separate member, allowing coffee grounds or biomass to be introduced into the rotating housing (110).

In an embodiment, the outlet (130) may be configured to connect to the rotating housing (110) directly or indirectly via a separate member, allowing coffee grounds or biomass to be discharged from the rotating housing (110).

In an embodiment, the infrared drying section (140) may be positioned inside the rotating housing (110). In an embodiment, the infrared drying section (140) may include a panel (141) and at least one infrared lamp (142) positioned on the panel (141). In an embodiment, the panel (141) may remain stationary when the rotating housing (110) rotates. In an embodiment, the panel (141) may remain fixed in position relative to the rotating housing (110), rotating together with the rotating housing (110). In an embodiment, the at least one infrared lamp (142) in the infrared drying section (140) may irradiate the coffee grounds or biomass being stirred inside the rotating housing (110) with infrared rays. In an embodiment, the infrared irradiation process may dry the coffee grounds or biomass being stirred inside the rotating housing (110). The infrared drying process is not limited to being performed by at least one infrared lamp (142) and may be carried out using various means capable of irradiating infrared rays.

In an embodiment, the ultraviolet irradiation section (not shown) may irradiate ultraviolet rays onto the coffee grounds or biomass passing through the cylindrical drying device (100). In an embodiment, the ultraviolet irradiation section may include at least one ultraviolet lamp (not shown). The at least one ultraviolet lamp may irradiate ultraviolet rays of various wavelength bands onto the coffee grounds or biomass. In an embodiment, the at least one ultraviolet lamp may include a first ultraviolet lamp, a second ultraviolet lamp, and/or a third ultraviolet lamp.

In an embodiment, the first ultraviolet lamp may be configured to irradiate ultraviolet rays in a first wavelength band. In an embodiment, the first wavelength band may be about 320 nm to about 400 nm, but is not limited thereto. In an embodiment, the first ultraviolet lamp may be a UV-A lamp irradiating ultraviolet rays in the first wavelength band, but is not limited thereto.

In an embodiment, the second ultraviolet lamp may be configured to irradiate ultraviolet rays in a second wavelength band different from the first wavelength band. In an embodiment, the second wavelength band may be about 290 nm to about 320 nm, but is not limited thereto. In an embodiment, the second ultraviolet lamp may be a UV-B lamp irradiating ultraviolet rays in the second wavelength band, but is not limited thereto.

In an embodiment, the third ultraviolet lamp may be configured to irradiate ultraviolet rays in a third wavelength band different from the first and second wavelength bands. In an embodiment, the third wavelength band may be about 200 nm to about 290 nm, but is not limited thereto. In an embodiment, the third ultraviolet lamp may be a UV-C lamp irradiating ultraviolet rays in the third wavelength band, but is not limited thereto.

In an embodiment, the first, second, and third ultraviolet lamps may be installed in the inlet (120) and outlet (130) to irradiate ultraviolet rays onto the coffee grounds or biomass passing through the inlet (120) and outlet (130). In an embodiment, the first, second, and third ultraviolet lamps may be installed inside the cylindrical housing (110) to irradiate ultraviolet rays onto the coffee grounds or biomass being stirred inside the cylindrical housing (110).

In an embodiment, the step of drying the coffee grounds may include both the infrared irradiation process and the ultraviolet irradiation process. In an embodiment, the infrared and ultraviolet irradiation processes for the coffee grounds may be performed simultaneously or at different times. In an embodiment, the coffee grounds may be stirred by the rotating housing (110) inside the rotating housing (110) and may be dried by infrared irradiation from the infrared lamp (142). In an embodiment, the infrared irradiation process may be performed until the moisture content of the coffee grounds is reduced to about 0.4% or less.

According to an embodiment, the infrared irradiation process for coffee grounds may be defined and interpreted as a process for drying coffee grounds through infrared radiant heat. In an embodiment, the infrared irradiation process for coffee grounds may be carried out within a temperature range of about 90° C. to about 95° C. inside the rotating housing (110) for a duration of about 30 minutes.

In an embodiment, the coffee grounds may be irradiated with ultraviolet light by the first ultraviolet lamp, second ultraviolet lamp, and third ultraviolet lamp, resulting in discoloration (or bleaching). In an embodiment, the ultraviolet irradiation process for coffee grounds may be performed for about 10 minutes.

According to an embodiment, the process of drying biomass may include an infrared irradiation process and an ultraviolet irradiation process. In an embodiment, the infrared and ultraviolet irradiation processes for biomass may be performed substantially simultaneously or at different times. In an embodiment, the biomass may be stirred by the rotating housing (110) inside the rotating housing (110) and may be dried by infrared irradiation from the infrared lamp (142). In an embodiment, the infrared irradiation process for biomass may be performed until the moisture content of the biomass is reduced to about 0.4% or less. In an embodiment, the biomass may be irradiated with ultraviolet light by the first ultraviolet lamp, second ultraviolet lamp, and third ultraviolet lamp, resulting in discoloration (or bleaching). In an embodiment, the ultraviolet irradiation process for biomass may be performed for about 10 minutes.

According to an embodiment, the infrared irradiation process for biomass may be defined and interpreted as a process for drying biomass through infrared radiant heat. In an embodiment, the infrared irradiation process for biomass may be carried out within a temperature range of about 60° C. to about 65° C. inside the rotating housing (110) for a duration of about 30 minutes.

In an embodiment, the coffee grounds may be irradiated with ultraviolet light by the first ultraviolet lamp, second ultraviolet lamp, and third ultraviolet lamp, resulting in discoloration (or bleaching). In an embodiment, the ultraviolet irradiation process for coffee grounds may be performed for about 10 minutes.

According to an embodiment, the drying process (P13) for coffee grounds and the drying process (P13) for biomass may be carried out separately due to differences in the material and moisture content of the coffee grounds and biomass.

According to an embodiment, a plastic composite material manufactured using the coffee grounds and biomass subjected to the ultraviolet irradiation process may exhibit a relatively lower degree of discoloration upon ultraviolet exposure compared to a plastic composite material manufactured using coffee grounds and biomass that were not subjected to the ultraviolet irradiation process. A more detailed explanation will be provided later.

Referring to FIG. 1, the method of manufacturing a plastic composite material including coffee grounds may include a process (P15) of freeze-grinding the dried coffee grounds. In an embodiment, the process of freeze-grinding dried coffee grounds may include a freezing process or a grinding process.

According to an embodiment, the freezing process for coffee grounds may be carried out by freezing dried coffee grounds using nitrogen gas. In an embodiment, the freezing process for coffee grounds may be defined and interpreted as a process of freezing dried coffee grounds within a temperature range of about −195° C. using nitrogen gas.

According to an embodiment, the grinding process for coffee grounds may be carried out by grinding the frozen coffee grounds. When coffee grounds are ground after the freezing process is performed, they may be more smoothly ground compared to when coffee grounds are ground without the freezing process.

According to an embodiment, the coffee grounds subjected to the freeze-grinding process (P15) may have a particle size distribution in which the proportion of coffee grounds particles with a particle size of about 250 μm to about 850 μm (micrometers) is about 94% by weight or more.

FIG. 3 is a graph showing the particle size distribution of coffee grounds before and after freeze-grinding according to an embodiment of the disclosure.

Table 1 below summarizes the particle size distribution of coffee grounds before and after freeze-grinding according to an embodiment of the disclosure

TABLE 1

| Particle Size | Before Freeze- | After Freeze- |
|---|---|---|
| Range | Grinding | Grinding |
| (μm) | (% by weight) | (% by weight) |
| <150 | 0.0 | 0.0 |
| 150 < x ≤ 180 | 0.2 | 0.1 |
| 180 < x ≤ 250 | 0.8 | 1.7 |
| 250 < x ≤ 425 | 19.7 | 48.6 |
| 425 < x ≤ 850 | 67.9 | 46.2 |
| >850 | 11.4 | 3.4 |

Referring to FIG. 3 and Table 1, before freeze-grinding, the coffee grounds may have a particle size distribution where the proportion of particles is about 0.0% by weight for particles with a size less than or equal to about 150 μm, about 0.2% by weight for particles with a size greater than about 150 μm and less than or equal to about 180 μm, about 0.8% by weight for particles with a size greater than about 180 μm and less than or equal to about 250 μm, about 19.7% by weight for particles with a size greater than about 250 μm and less than or equal to about 425 μm, about 67.9% by weight for particles with a size greater than about 425 μm and less than or equal to about 850 μm, and about 11.4% by weight for particles with a greater than about 850 μm. Referring to FIG. 3 and Table 1, after freeze-grinding, the coffee grounds may have a particle size distribution where the proportion of particles is about 0.0% by weight for particles with a size greater than about 150 μm, about 0.1% by weight for particles with a size greater than about 150 μm and less than or equal to about 180 μm, about 1.7% by weight for particles with a size greater than about 180 μm and less than or equal to about 250 μm, about 48.6% by weight for particles with a size greater than about 250μm and less than or equal to about 425 μm, about 46.2% by weight for particles with a size greater than about 425 μm and less than or equal to about 850 μm, and about 3.4% by weight for particles with a size greater than 850 μm.

According to an embodiment, the coffee grounds subjected to the freeze-grinding process (P15) may have a particle size distribution where the proportion of coffee grounds particles with a particle size greater than about 250 μm and less than or equal to about 850 μm is about 95% by weight.

According to an embodiment, the weight ratio of the first particle size range (e.g., greater than about 250 μm and less than or equal to about 850 μm) in the coffee grounds subjected to the freeze-grinding process (P15) may be greater than the weight ratio of other particle size ranges.

According to an embodiment, the plastic composite material including the coffee grounds subjected to the freeze-grinding process (P15) may exhibit a uniform distribution of coffee grounds in the appearance of molded articles made of the plastic composite material due to the higher weight ratio of the first particle size range compared to other particle size ranges.

Referring to FIG. 1, the method for manufacturing a plastic composite material including coffee grounds may include a process (P17) of primarily extruding a first mixture obtained by mixing a polymer resin, the coffee grounds, dried biomass, and a first additive.

According to an embodiment, the method for manufacturing a plastic composite material including coffee grounds may include a process (P19) of secondarily extruding a second mixture obtained by mixing the primary extrudate with a second additive

According to an embodiment, the primary extrusion process (P17) and/or the secondary extrusion process (P19) may be performed using an extruder, which may be a twin extruder. In an embodiment, the primary extrusion process (P17) may be performed by extruding the first mixture, obtained by mixing a polymer resin, the ground coffee grounds, dried biomass, and a first additive, to form a first extrudate (or primary extrudate). In an embodiment, the secondary extrusion process (P19) may be performed by extruding the second mixture, obtained by mixing the first extrudate with a second additive, to form a second extrudate (or secondary extrudate).

Table 2 below shows the weight ratios of additives added in the primary extrusion process (P17) and the secondary extrusion process (P19) according to an embodiment of the disclosure.

TABLE 2

| Process | Material | Wt. part |
|---|---|---|
| Primary Extrusion (P17) | Polymer Resin | 100 |
| | Coffee Grounds | 3-30 |
| | Biomass | 3-10 |
| | Antioxidant | 0.1-2 |
| | Compatibilizer | 3-5 |
| | Impact Modifier | 8-35 |
| Secondary Extrusion | UV Stabilizer | 0.1-18 |
| (P19) | Pigment | 0.1-2 |

According to an embodiment, the primary extrusion process (P17) may be performed by primarily extruding a first mixture, which is obtained by mixing the ground coffee grounds, dried biomass, and a first additive with a polymer (resin), to form a first extrudate. In an embodiment, the first additive may include at least one of an antioxidant, a compatibilizer, or an impact modifier. In an embodiment, the primary extrusion process (P17) may involve feeding the first mixture, which includes a polymer resin (or polymer), ground coffee grounds, dried biomass, and a first additive, into an extruder through a main feeder and a sub-feeder and extruding the fed materials to form a first extrudate. In an embodiment, the weight ratio of materials fed through the main feeder and the sub-feeder may be about 80:20. In an embodiment, the primary extrusion process (P17) may be performed at a temperature range of about 170° C. to about 180° C. using an extruder screw with a diameter (Ø) of about 32 or more in a twin-screw extruder.

According to an embodiment, the weight ratio of materials fed in the primary extrusion process (P17) may be about 3 to about 30 parts by weight of ground coffee grounds, about 3 to about 10 parts by weight of dried biomass, and about 3.4 to about 37 parts by weight of the first additive, based on about 100 parts by weight of the polymer resin (or polymer).

In an embodiment, the polymer resin may include at least one selected from the group consisting of polypropylene-based polymer resins, polyethylene-based polymer resins, polystyrene-based polymer resins, acrylonitrile-butadiene-styrene (ABS) copolymer-based polymer resins, polyoxymethylene-based polymer resins, polyketone-based polymer resins, thermoplastic elastomer-based resins, and biodegradable polymer resins.

According to an embodiment, the first additive may include at least one of an antioxidant, a compatibilizer, or an impact modifier.

In an embodiment, the antioxidant may include at least one selected from the group consisting of a phenol-based primary antioxidant or a phosphorous-based secondary antioxidant. In an embodiment, the weight ratio of the antioxidant added in the primary extrusion process (P17) may be about 0.1 to about 2 parts by weight, based on about 100 parts by weight of the polymer resin (or polymer).

According to an embodiment, the compatibilizer may include at least one selected from the group consisting of a polypropylene compatibilizer or a polyolefin-based compatibilizer used with polyethylene. In an embodiment, the weight ratio of the compatibilizer added in the primary extrusion process (P17) may be about 3 to about 5 parts by weight, based on 100 parts by weight of the polymer resin (or polymer).

In an embodiment, the impact modifier may include at least one selected from the group consisting of an olefin-based impact modifier, a silicon-based impact modifier, an acrylonitrile, butadiene, styrene (ABS)-based impact modifier, or a polyester-based elastomer impact modifier. In an embodiment, the weight ratio of the impact modifier added in the primary extrusion process (P17) may be about 8 to about 35 parts by weight, based on about 100 parts by weight of the polymer resin (or polymer).

According to an embodiment, the secondary extrusion process (P19) may be performed by secondarily extruding a second mixture, which is obtained by mixing the first extrudate with a second additive, to form a second extrudate.

In an embodiment, the secondary extrusion process (P19) may involve feeding the second mixture, which includes the first extrudate and the second additive, into an extruder through the main feeder and extruding the fed materials to form a second extrudate.

According to an embodiment, the weight ratio of the second additive added in the secondary extrusion process (P19) may be about 0.2 to about 20 parts by weight, based on about 100 parts by weight of the polymer resin added in the primary extrusion process (P17).

In an embodiment, the second additive may include at least one of a UV stabilizer or a pigment.

According to an embodiment, the UV stabilizer may include at least one selected from the group consisting of an absorber-type UV stabilizer, a HALS (hindered amine light stabilizer) UV stabilizer, peroxide decomposer UV stabilizer, a radical inhibitor UV stabilizer, or a quencher UV stabilizer. In an embodiment, the weight ratio of the UV stabilizer added in the secondary extrusion process (P19) may be about 0.1 to about 18 parts by weight, based on about 100 parts by weight of the polymer resin (or polymer) added in the primary extrusion process (P17).

In an embodiment, the pigment may include at least one selected from the group consisting of an organic pigment or an inorganic pigment. In an embodiment, the weight ratio of the pigment added in the secondary extrusion process (P19) may be about 0.1 to about 2 parts by weight, based on about 100 parts by weight of the polymer resin (or polymer) added in the primary extrusion process (P17).

According to an embodiment, the secondary extrusion process (P19) may be performed at a temperature range of about 110° C. to about 160° C. using an extruder screw with a diameter (Ø) of about 32 or more in a twin-screw extruder.

According to an embodiment, the method for manufacturing a plastic composite material including coffee grounds may include a process (P21) of infrared drying the second extrudate. In an embodiment, the process (P21) of infrared drying the second extrudate may be performed within a temperature range of about 85° C. to about 90° C. for a duration of about 30 minutes inside the rotating housing (110). In an embodiment, through the infrared drying process, a dried plastic composite material may be formed from the second extrudate.

According to an embodiment, the method for manufacturing a plastic composite material including coffee grounds may include a process (P23) of packaging the dried composite material.

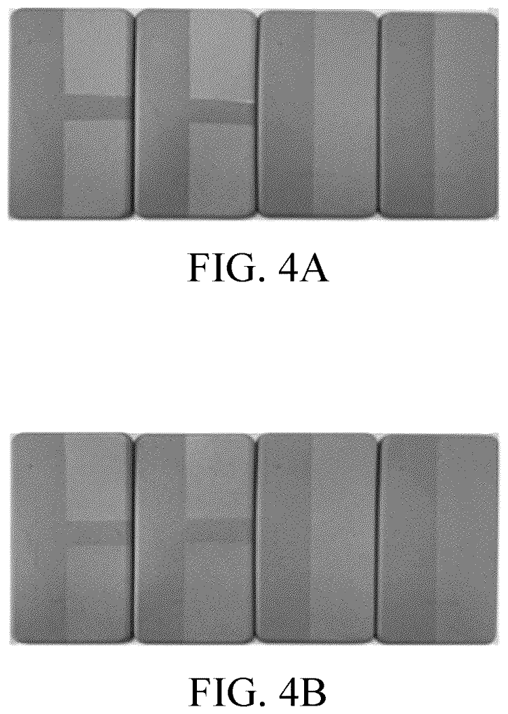

FIG. 4A is a view illustrating a plastic composite material according to an embodiment of the disclosure. FIG. 4B is a view illustrating a plastic composite material according to an embodiment of the disclosure.

The embodiments shown in FIGS. 4A and 4B may be combined with the embodiments shown in FIGS. 1, 2A, 2B, and 3.

The comparative example in FIG. 4A represents a plastic composite material manufactured by adding a UV stabilizer without performing UV irradiation on the dried coffee grounds in the method for manufacturing a plastic composite material including coffee grounds as shown in FIG. 1, while the embodiment in FIG. 4B represents a plastic composite material manufactured by performing UV irradiation on the dried coffee grounds and adding a UV stabilizer in the method for manufacturing a plastic composite material including coffee grounds as shown in FIG. 1.

Referring to FIG. 4B, it can be confirmed that the discoloration rate of the plastic composite material is lower compared to FIG. 4A.

The colorimetric value, that is, degree of discoloration (ΔE), of a plastic composite material that has not undergone the UV irradiation process may be about 5.35 for UV-A and about 3.95 for UV-B.

The colorimetric value, that is, degree of discoloration (ΔE), of a plastic composite material that has undergone the UV irradiation process may be about 4.4 for UV-A and about 3.0 for UV-B.

According to an embodiment, the plastic composite material that has undergone the UV irradiation process may exhibit a lower degree of discoloration upon prolonged UV exposure compared to a plastic composite material that has not undergone the UV irradiation process.

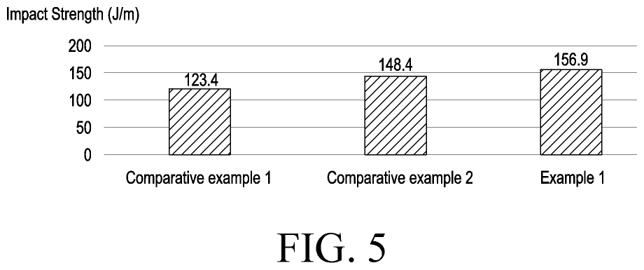

FIG. 5 is a graph showing the impact strength of a plastic composite material according to an embodiment of the disclosure.

The embodiment shown in FIG. 5 may be combined with the embodiments shown in FIGS. 1, 2A, 2B, 3, 4A, and 4B.

Table 3 below summarizes the physical property values of plastic composite materials according to a comparative example or an embodiment of the disclosure.

TABLE 3

| | C. Ex. 1 | C. Ex. 2 | Ex. 1 |
|---|---|---|---|
| Impact Strength (J/m) | 123.4 | 148.4 | 156.9 |
| Tensile Strength (MPa) | 14.5 | 15.2 | 15.3 |
| Tensile Modulus (MPa) | 1,303 | 1,291 | 1,426 |
| Flexural Strength (MPa) | 19.3 | 19.7 | 20.2 |
| Flexural Modulus (MPa) | 997 | 955 | 1,045 |

The plastic composite material of Comparative Example 1 may be a plastic composite material manufactured without using biomass, using undried coffee grounds in the method for manufacturing a plastic composite material including coffee grounds as shown in FIG. 1. The plastic composite material of Comparative Example 2 may be a plastic composite material manufactured using biomass and using undried biomass and coffee grounds. The plastic composite material of Embodiment 1 may be a plastic composite material manufactured using biomass and using dried biomass and coffee grounds. It can be confirmed that the plastic composite material (Embodiment 1), which is manufactured using biomass and using dried biomass and coffee grounds, has improved impact strength, tensile strength, Young's modulus, flexural strength, or flexural modulus compared to Comparative Example 1 or Comparative Example 2.

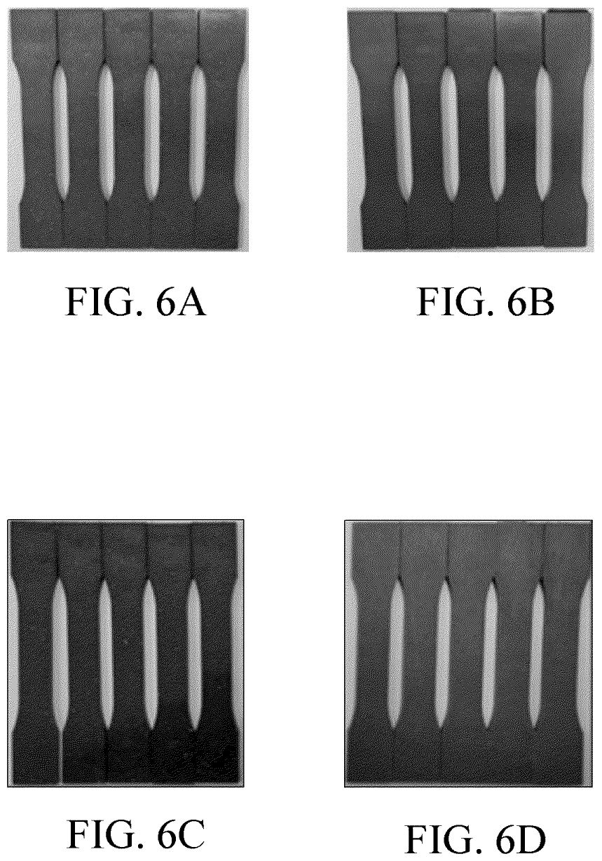

FIG. 6A is a view illustrating a plastic composite material according to an embodiment of the disclosure. FIG. 6B is a view illustrating a plastic composite material according to an embodiment of the disclosure. FIG. 6C is a view illustrating a plastic composite material according to an embodiment of the disclosure. FIG. 6D is a view illustrating a plastic composite material according to an embodiment of the disclosure.

The embodiments shown in FIGS. 6A to 6D may be combined with the embodiments shown in FIGS. 1, 2A, 2B, 3, 4A, 4B, and 5.

The plastic composite material in FIG. 6A is a plastic composite material manufactured by performing only the primary extrusion process (P17) without performing the secondary extrusion process (P19) in the method for manufacturing a plastic composite material including coffee grounds as shown in FIG. 1, using a twin-screw extruder (with an extrusion screw diameter (Ø) of 32). This plastic composite material can be confirmed to have an impact strength of 152 (J/m). The plastic composite material in FIG. 6B is a plastic composite material manufactured by performing both the primary extrusion process (P17) and the secondary extrusion process (P19) in the method for manufacturing a plastic composite material including coffee grounds as shown in FIG. 1, using a twin-screw extruder (with an extrusion screw diameter (Ø) of 32), with the impact strength thereof found to be 180 (J/m).

The plastic composite material in FIG. 6C is a plastic composite material manufactured by performing the primary extrusion process (P17) without performing the secondary extrusion process (P19) in the method for manufacturing a plastic composite material including coffee grounds as shown in FIG. 1, using a twin-screw extruder (with an extrusion screw diameter (Ø) of 75), with the impact strength thereof found to be about 152 (J/m). The plastic composite material in FIG. 6D is a plastic composite material manufactured by performing both the primary extrusion process (P17) and the secondary extrusion process (P19) in the method for manufacturing a plastic composite material including coffee grounds as shown in FIG. 1, using a twin-screw extruder (with an extrusion screw diameter (Ø) of 75), with the impact strength thereof found to be 180 (J/m).

Compared to the cross-sections of the plastic composite material in FIG. 6A or 6C, the cross-sections of the plastic composite material in FIG. 6B or 6D can be confirmed to have relatively uniform surfaces (or appearances).

Compared to the plastic composite material in FIG. 6A or 6C, the plastic composite material in FIG. 6B or FIG. 6D can be confirmed to have relatively improved impact strength.

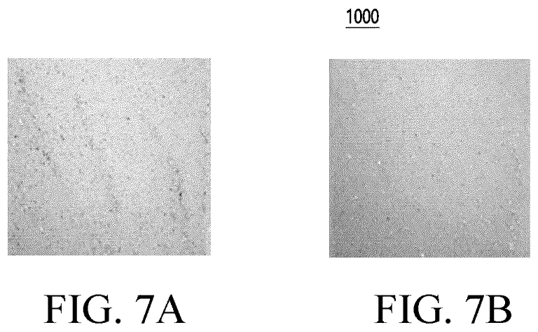

FIG. 7A is an image illustrating a plastic composite material according to an embodiment of the disclosure. FIG. 7B is an image illustrating a plastic composite material according to an embodiment of the disclosure.

The embodiments shown in FIGS. 7A and 7B may be combined with the embodiments shown in FIGS. 1, 2A, 2B, 3, 4A, 4B, 5, and 6A to 6D.

The plastic composite material in FIG. 7A may be a plastic composite material manufactured without performing the freeze-grinding process (P15) in the method for manufacturing a plastic composite material including coffee grounds as shown in FIG. 1. The plastic composite material (1000) in FIG. 7B may be a plastic composite material manufactured by performing the grinding process (P15) in the method for manufacturing a plastic composite material including coffee grounds as shown in FIG. 1.

Compared to the plastic composite material in FIG. 7A, the plastic composite material (1000) in FIG. 7B can be confirmed to have a surface (or appearance) with a relatively uniform particle size distribution.

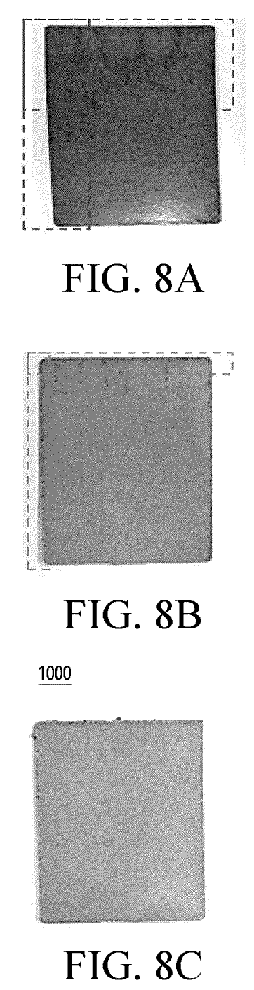

FIGS. 8A and 8B are images illustrating plastic composite materials according to various embodiments of the disclosure. FIG. 8C is an image illustrating a plastic composite material according to an embodiment of the disclosure.

The embodiments shown in FIGS. 8A to 8C may be combined with the embodiments shown in FIGS. 1, 2A, 2B, 3, 4A, 4B, 5, 6A to 6D, 7A and 7B.

The plastic composite material in FIG. 8A may be a plastic composite material manufactured without performing the freeze-grinding process (P15) and the secondary extrusion process (P19) in the method for manufacturing a plastic composite material including coffee grounds as shown in FIG. 1. The plastic composite material in FIG. 8B may be a plastic composite material manufactured without performing the freeze-grinding process (P15) but performing the secondary extrusion process (P19) in the method for manufacturing a plastic composite material including coffee grounds as shown in FIG. 1. The plastic composite material (1000) in FIG. 8C may be a plastic composite material manufactured by performing both the freeze-grinding process (P15) and the secondary extrusion process (P19) in the method for manufacturing a plastic composite material including coffee grounds as shown in FIG. 1.

Compared to the plastic composite material in FIG. 8A, the plastic composite material (1000) in FIG. 8C can be confirmed to have a relatively uniform surface (or appearance) without occurrence of indentation at one end (or terminal) of the plastic composite material.

Compared to the plastic composite material in FIG. 8B, the plastic composite material (1000) in FIG. 8C can be confirmed to have a relatively uniform surface (or appearance).

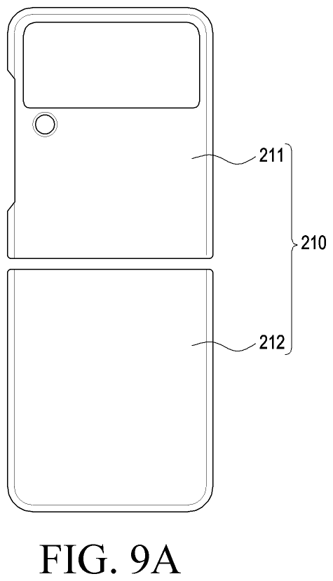

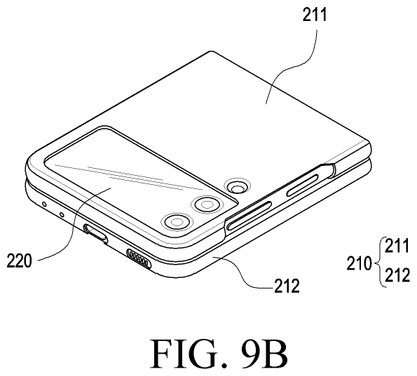

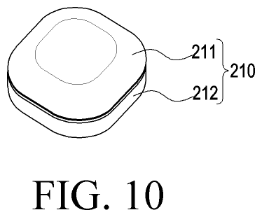

FIGS. 9A and 9B are diagrams illustrating a cover member composed of a plastic composite material according to various embodiments of the disclosure. FIG. 10 is a diagram illustrating a cover member composed of a plastic composite material according to an embodiment of the disclosure.

The embodiments shown in FIGS. 9A to 10 may be combined with the embodiments shown in FIGS. 1, 2A, 2B, 3, 4A, 4B, 5, 6A to 6D, 7A, 7B, 8A, and 8B.

Referring to FIGS. 9A, 9B, and 10, the cover member (210) may include a first cover (211) and a second cover (212). In an embodiment, the first cover (211) and the second cover (212) may each be a cover member molded from the plastic composite material manufactured by the method for manufacturing a plastic composite material including coffee grounds as shown in FIG. 1.

Referring to FIGS. 9A and 9B, the cover member (210) may be used as a cover member for an electronic device (220) (e.g., a foldable smartphone) configured to fold or unfold at least in part.

Referring to FIG. 10, the cover member (210) may be used as a cover member for an earphone-type electronic device (e.g., wireless Bluetooth earphones).

The plastic composite material according to an embodiment of the disclosure is not limited to being used as a cover member for electronic devices and may also be used for various members, including exterior parts for vehicles.

Technologies related to plastic composite materials utilizing coffee grounds, the residue left after extracting coffee from coffee beans, are being presented. Although related technologies propose plastic composite materials including coffee grounds, they merely include coffee grounds without presenting additional processes necessary when adding coffee grounds.

In the plastic composite materials including coffee grounds in related technologies, the particle size of the coffee grounds is non-uniform, resulting in an uneven surface on the plastic composite material, which reduces product quality. Additionally, the non-uniform particle size of the coffee grounds in these related technologies causes additives to be unevenly mixed during manufacturing, leading to lower physical property values in the plastic composite material.

According to an embodiment of the disclosure, a plastic composite material including coffee grounds with a smooth surface (or appearance), a method for manufacturing the same, a product using it, and the characteristics of the product can be provided.

According to an embodiment of the disclosure, a plastic composite material including coffee grounds with improved physical properties and a method for manufacturing same can be provided.

However, the problems to be solved by the disclosure are not limited to those mentioned above and can be variously defined without departing from the spirit and scope of the disclosure.

According to an embodiment of the disclosure, the plastic composite material, by including coffee grounds with a uniform particle size distribution, may have an aesthetically pleasing product surface.

According to an embodiment of the disclosure, the plastic composite material may have reduced discoloration due to ultraviolet light.

According to an embodiment of the disclosure, the plastic composite material may retain its physical properties even when coffee grounds are included.

The effects obtainable from the disclosure are not limited to those mentioned above, and other effects not mentioned will be clearly understood from the following description by those skilled in the art to which the disclosure belongs.

According to an example of the disclosure, the plastic composite material (e.g., the plastic composite material (1000) in FIG. 7B or FIG. 8C) may include coffee grounds. The coffee grounds may have a particle size distribution of 94% by weight or more for coffee grounds particles with a particle size greater than 250 μm and less than or equal to 850 μm. The colorimetric value of the plastic composite material may be 4.0 or less.

According to an embodiment, the coffee grounds may have a particle size distribution of 48.6% by weight or more for coffee grounds particles with a particle size greater than 250 μm and less than or equal to 425 μm (inclusive). The coffee grounds may have a particle size distribution of 46.2% by weight or more for coffee grounds particles with a particle size greater than 425 μm and less than or equal to 850 μm.

According to an embodiment, the weight ratio of coffee grounds particles with a particle size greater than 250 μm and less than or equal to 850 μm may be at least 52 times the weight ratio of coffee grounds particles with a particle size greater than 180 μm and less than or equal to 250 μm.

According to an example, weight ratio of coffee grounds particles with a particle size greater than 850 μm may be 3.4% by weight or less.

According to an example, the colorimetric value of the plastic composite material may be 4.4 or less for UV-A. In an example, the colorimetric value of the plastic composite material may be 3.0 or less for UV-B.

According to an example, the impact strength of the plastic composite material may be 123.4 (J/m) to 190.4 (J/m).

According to an example, the tensile strength of the plastic composite material may be 14.5 MPa to 16.1 MPa.

According to an example, the Young's modulus of the plastic composite material may be 1,291 MPa to 1,561 MPa.

According to an example, the flexural strength of the plastic composite material may be 19.3 MPa to 21.1 MPa.

According to an example, the flexural modulus of the plastic composite material may be 955 MPa to 1,135 MPa.

According to an embodiment of the disclosure, the method for manufacturing a plastic composite material including coffee grounds may include the processes of: preparing coffee grounds and biomass (e.g., process P11 in FIG. 1); drying the coffee grounds and the biomass (e.g., process P13 in FIG. 1); freeze-grinding the dried coffee grounds (e.g., process P15 in FIG. 1) wherein the coffee grounds formed by grinding the dried coffee grounds have a particle size distribution in which coffee grounds particles with a particle size greater than 250 μm and less than or equal to 850 μm are present in an amount of 94% by weight or more; primarily extruding a first mixture obtained by mixing a polymer resin, the ground coffee grounds, the dried biomass, and a first additive (e.g., process P17 in FIG. 1); secondarily extruding a second mixture obtained by mixing the first extrudate extruded in the primary extrusion process and a second additive (e.g., process P19 in FIG. 1); and drying the second extrudate extruded in the secondary extrusion process (e.g., process P21 in FIG. 1).

According to an embodiment, the drying process may include drying the coffee grounds and biomass separately.

According to an embodiment, the drying process may include an infrared irradiation process and an ultraviolet irradiation process.

According to an embodiment, the ultraviolet irradiation process may include irradiating at least one of UV-A, UV-B, or UV-C onto the coffee grounds or biomass.

According to an embodiment, the infrared irradiation process may be performed until the moisture content of the coffee grounds or biomass is reduced to 4% or less.

According to an example, the biomass may include at least one selected from the group consisting of wood meal, rice straw, rice husk, rice bran, soybean hull, or wheat bran.

According to an example, the polymer resin may include at least one selected from the group consisting of polypropylene-based polymer resins, polyethylene-based polymer resins, polystyrene-based polymer resins, acrylonitrile-butadiene-styrene copolymer-based resins, polyoxymethylene-based polymer resins, polyketone-based polymer resins, thermoplastic elastomer-based resins, or biodegradable polymer resins.

According to an example, the first additive may include at least one of an antioxidant, a compatibilizer, or an impact modifier.

According to an embodiment, the second additive may include at least one of a UV stabilizer or a pigment.

According to an example, the weight ratio of the ground coffee grounds added in the primary extrusion process may be 3 to 30 parts by weight, based on 100 parts by weight of the polymer resin. The weight ratio of the dried biomass added in the primary extrusion process may be 3 to 10 parts by weight, based on 100 parts by weight of the polymer resin. The weight ratio of the first additive added in the primary extrusion process may be 3.4 to 37 parts by weight, based on 100 parts by weight of the polymer resin. The weight ratio of the second additive added in the secondary extrusion process may be 0.2 to 20 parts by weight, based on 100 parts by weight of the polymer resin added in the primary extrusion process.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A plastic composite material, comprising coffee grounds,
wherein the coffee grounds have a particle size distribution of 94% by weight or more for coffee grounds particles with a particle size greater than 250 μm and less than or equal to 850 μm, and
wherein the plastic composite material has a colorimetric value of 4.4 or less.

2. The plastic composite material of claim 1, wherein the coffee grounds have a particle size distribution of 48.6% by weight or more for coffee grounds particles with a particle size greater than 250 μm and less than or equal to 425 μm, and 46.2% by weight or more for coffee grounds particles with a particle size greater than 425 μm and less than or equal to 850 μm.

3. The plastic composite material of claim 1, wherein the coffee grounds particles with a particle size greater than 250 μm and less than or equal to 850 μm has a weight ratio 52 times greater than the weight ratio of the coffee grounds particles with a particle size greater than 180 μm and less than or equal to 250 μm.

4. The plastic composite material of claim 1, wherein the coffee grounds particles with a particle size of greater than 850 μm is a weight ratio of 3.4% by weight or less.

5. The plastic composite material of claim 1, wherein the plastic composite material has a colorimetric value of 4.4 or less for ultraviolet (UV)-A and 3.0 or less for UV-B.

6. The plastic composite material of claim 1, wherein the plastic composite material has an impact strength of 123.4 (J/m) to 190.4 (J/m).

7. The plastic composite material of claim 1, wherein the plastic composite material has a tensile strength of 14.5 MPa to 16.1 MPa.

8. The plastic composite material of claim 1, wherein the plastic composite material has a Young's modulus of 1,291 MPa to 1,561 MPa.

9. The plastic composite material of claim 1, wherein the plastic composite material has a flexural strength of 19.3 MPa to 21.1 MPa.

10. The plastic composite material of claim 1, wherein the plastic composite material has a flexural modulus of 955 MPa to 1,135 MPa.

11. A method for manufacturing a plastic composite material comprising coffee grounds, the method comprising:
preparing coffee grounds and biomass;
drying the coffee grounds and the biomass;
freeze-grinding the dried coffee grounds, wherein the coffee grounds formed by grinding the dried coffee grounds have a particle size distribution of 94% by weight or more for coffee grounds particles with a particle size greater than and 250 μm less than or equal to 850 μm;
primarily extruding a first mixture obtained by mixing a polymer resin, the ground coffee grounds, the dried biomass, and a first additive;
secondarily extruding a second mixture obtained by mixing the first extrudate extruded in the primary extrusion process and a second additive; and
drying the second extrudate extruded in the secondary extrusion process.

12. The method of claim 11, wherein the drying process is a process of separately drying the coffee grounds and the biomass.

13. The method of claim 11, wherein the drying process comprises an infrared irradiation process and an ultraviolet irradiation process.

14. The method of claim 13, wherein the ultraviolet irradiation process is a process of irradiating at least one of ultraviolet (UV)-A, UV-B, or UV-C onto the coffee grounds or the biomass.

15. The method of claim 14, wherein the ultraviolet irradiation process is a process of irradiating the coffee grounds or the biomass with UV-A from a first UV lamp, UV-B from a second UV lamp, and UV-C from a third UV lamp.

16. The method of claim 13, wherein the infrared irradiation process is performed until the coffee grounds or the biomass has moisture content of 0.4% or less.

17. The method of claim 13, wherein the drying process comprises performing the infrared irradiation process and the UV irradiation process simultaneously.

18. The method of claim 11,
wherein the first additive comprises at least one of an antioxidant, a compatibilizer, or an impact modifier, and
wherein the second additive comprises at least one of an ultraviolet stabilizer or a pigment.

19. The method of claim 18,
wherein the antioxidant includes at least one selected from the group consisting of a phenol-based primary antioxidant or a phosphorous-based secondary antioxidant additive includes at least one of an ultraviolet stabilizer or a pigment,
wherein the compatibilizer may include at least one selected from the group consisting of a polypropylene compatibilizer or a polyolefin-based compatibilizer used with polyethylene, and
wherein the impact modifier may include at least one selected from the group consisting of an olefin-based impact modifier, a silicon-based impact modifier, an acrylonitrile, butadiene, styrene (ABS)-based impact modifier, or a polyester-based elastomer impact modifier.

20. The method of claim 18,
wherein the UV stabilizer comprises at least one selected from the group consisting of an absorber-type UV stabilizer, a hindered amine light stabilizer (HALS) UV stabilizer, a peroxide decomposer UV stabilizer, a radical inhibitor UV stabilizer, or a quencher UV stabilizer, and
wherein the pigment comprises at least one selected from the group consisting of an organic pigment or an inorganic pigment.
